(19) United States
(12) Patent Application Publication
(10) Pub. No.: US 2004/0006655 A1
(43) Pub. Date: Jan. 8, 2004

(54) Method for protecting nomad devices against theft, corresponding device and installation

(76) Inventor: Richard Toffolet, Paris (FR)

Correspondence Address: YOUNG & THOMPSON, 745 SOUTH 23RD STREET 2ND FLOOR, ARLINGTON, VA, 22202

(21) Appl. No.: 10/450,258

(22) PCT Filed: Dec. 14, 2001
(86) PCT No.: PCT/FR01/03997

(30) Foreign Application Priority Data
Dec. 18, 2000 (FR) 00 16486

(51) Int. Cl. G06F 3/00

(52) U.S. Cl. 710/1

(57) ABSTRACT

Protection devices, such as portable telephones or computers, whereof the operating conditions is capable of being controlled by a software and which have a link dependence and/or of proximity with a removable component. The invention consists in inputting, prior to any severance of the dependence and/or proximity link, a code by the user, and in locking the device if the code is not input, optionally sending a warning message to a manager of the external service.

The present invention concerns the field of the fight against the theft or fraudulent use of devices the operation of which is likely to be under the control of software, the corresponding devices and an installation enabling this method to be implemented.

In particular, communication terminals may be concerned, that is, in the sense attributed in this case to “communication terminal”, any structure enabling communication (transmission/reception) with an external transceiver, whether this constitutes the or one essential function of said structure, as in the case of mobile phones, portable computers, etc., or a function made possible by means likely to be included therein, as in the case of a motor vehicle, a boat, an airplane, etc. Devices not normally providing a communication function, such as camcorders, cameras, etc may also be concerned.

Currently, the development of new technology is tending toward the “all-portable”, leading to a proliferation of communication devices or equipment referred to as “mobile”, that is to say portable or able to be integrated into various environments or, more simply, those for which operation is not attached to any specific place. This development of a new generation of portable, and therefore relatively small and light, equipment has been accompanied by an increase in thefts and/or fraudulent usage after they are lost.

There has therefore been growing interest in the development of systems for preventing the use of stolen or mislaid equipment, thus deterring any potential thief from carrying out the theft and encouraging the return of lost equipment to lost-and-found.

As regards mobile phones, a first approach involved taking advantage of the fact that some devices are “dedicated”, that is to say they include an additional line of programming such that they cannot operate with a SIM (Subscriber Identity Module) card other than the one which was provided with the subscription taken out from an operator. In the event that the device is stolen or lost, it is possible to inform the operator thereof so that the operator blocks the subscription.

However, the interruption to the subscription is not automatic but requires the user to interact with the operator.

Another drawback of this method lies in the fact that the thief can easily obtain the computer codes enabling him to unlock the device and open the possibility for said device to operate with another SIM card.

In addition, this method is not suitable for devices in which the SIM card can be replaced with another SIM card. It would then be necessary to be able to block not only the subscription but also the device itself.

One known method uses, for mobile phones, a system of codes referred to as PIN (Personal Identification Number) codes and PUK (Personal Unlocking Key) codes which the user chooses himself and which he enters into the memory of the phone. The device needs the PIN code(s) to be able to read the SIM card and to allow the device to be used. Consequently, each time the device is switched on, the user must enter the PIN code(s), which limits the risk of fraudulent use of the device, but is extremely tedious. In addition, if the phone is stolen while it is switched on, the thief needs only to refrain from switching it off in order to use it. This method has the additional drawback of requiring entry of one or more codes, the functions of which are often misunderstood by the users, leading to keying errors causing untimely blocking of the device. In addition, the PIN codes used can be easily decrypted, reducing their usefulness.

Such a blocking method using various PIN codes and the IMSI (International Mobile Subscriber Identity) code stored in the SIM card is described in EP 0 607 767.

The aim of the invention is to overcome the drawbacks of the prior art, and to this end, according to a first aspect, the invention proposes a method for combating the theft and/or fraudulent use of a device the operation of which is likely to be under the control of software and which has a dependence and/or proximity link with at least one removable component, referred to as an “in-place component”, which method is characterized in that it includes the following steps:

a) the loading, into said device, of protection software in which an activation code that is personal to the user, or any other personal authentication method (for example, the recognition of fingerprints, of the iris of the eye, of the DNA signature, etc.), is recorded and which the user requires to be able to break said dependence and/or proximity link,

b) the provision of said activation code to the authorized user, and, if said activation code was not entered in the device before the breakage of said dependence and/or proximity link:

c) the blocking of the operation of the device, under the command of said protection software.

In the present description and in the claims:

“removable component” is to be understood to mean any element, hardware (such as a smartcard, a computer peripheral device, any other device, etc.) as well as non-hardware (for example software) with which the device has a dependence and/or proximity link;

“dependence link” is to be understood to mean the fact that the removable component is required by design for the operation of the device (such as a SIM card for a mobile phone or a film for a camera) or, more generally, the fact that the removable component is physically joined to said device whether or not it is required for its operation (such as a printer connected to a computer central processing unit), it being understood that the same device can have a dependence link with several removable components;

“proximity link” is to be understood to mean the fact that the removable component, without being required for operation of the device, cannot be moved further than a predetermined distance away without triggering a signal, it being understood, in a manner similar to the dependence link, that the same device can have a proximity link with several removable components (means for creating such a proximity link exist, for example, in the field of anti-theft devices for luggage, one anti-theft element being provided in the luggage and the other element in the pocket of the carrier, and an alarm being triggered by the two elements moving apart);

“key” is to be understood to mean any remote-transmittable code and that is specific either to said component, such as the IMSI code of a SIM card, or to the device, such an IMEI (International Mobile Equipment Identity) code.

It will have been understood that the invention takes advantage of the fact that the first act committed on a device, the thief or fraudulent user of which can be identified or located through the component key of the in-place component, for example the IMSI code of the SIM card of a mobile phone, is the extraction of the in-place component with a view to replacing it with an equivalent component. Likewise, regarding the theft for example of a computer, the first act of the thief will be to disconnect it from its peripheral devices. By checking the legitimacy of this extraction or disconnection, the method according to the invention results in the theft being of no benefit and fraudulent use being impossible, doing so in a very simple manner since the user need merely register himself via the controller of the protection service and load the protection software into his device in order to gain the assurance that the in-place component with which his device has a dependence link will not be able to be extracted or disconnected by someone who does not know the activation code without resulting in said device being blocked.

Another scenario is based on the fact that, once the device is stolen, the thief will flee and therefore move away from the original location of said device where the removable component, with which the device has a proximity link, is located. By making use of the predetermined distance being exceeded, the method according to the invention results in the theft being of no benefit and fraudulent use being impossible, since the owner of the device has the assurance that, as soon as the distance between said removable component and said stolen device exceeds the predetermined distance, and the activation code has not been entered beforehand, said device is then blocked immediately.

It is understood that the activation code is entered in the device by the authorized user only if he wishes to replace the in-place component with an equivalent component or to temporarily disconnect the in-place component for whatever reason, in which case the method relies on the breakage of the dependence link, or if he wishes to move the device away from said removable component, by further than the predetermined distance, all these operations being very infrequent; the protection of the device therefore involves no repetitive and tedious manipulation.

According to one preferred embodiment of the invention, the method additionally includes a step consisting of:

d) the initiation, through the effect of entering the activation code in the device, of a timer providing the time required to break and re-establish the dependence and/or proximity link, and if necessary

e) the blocking of the device if the dependence and/or proximity link was not re-established before the end of said time period of the timer.

“Timer” is to be understood to mean any action aiming to set a predetermined duration.

“Re-establishment of the dependence and/or proximity link” is to be understood to mean, in the case of the dependence link, the substitution of an equivalent component for the in-place component or the reconnection of the temporarily disconnected in-place component, and, in the case of the proximity link, the bringing of the device and the removable component closer together to a distance less than the predetermined separation distance.

Step e) is provided to avoid the scenario in which the authorized user can leave the protection unlocked without re-establishing the dependence and/or proximity link, which would allow, if the device were stolen in this state, said device to be used by a third party.

In one preferred embodiment, the method according to the invention additionally includes a step consisting of:

f) the blocking of the device in the event of successive inputs of a predetermined number of erroneous activation codes.

Since the terminal may be blocked as a result of an error by the authorized user, the method according to the invention advantageously provides for the possibility of a step consisting of:

g) the unblocking of said device by the provider of the activation code.

In one preferred embodiment applied to the case in which the device is a communication terminal, said terminal and said in-place component each having its specific key, respectively referred to as “terminal key” and “component key”, the method additionally includes the steps consisting of:

h) the recording in external equipment, including a database and a transceiver, of at least one item of data identifying the authorized user of said terminal;

i) the communication by the terminal, to said transceiver of the external equipment, of the terminal key and of the component key of said in-place component during first use of the method;

j) the recording, in said database, of the terminal key and of the component key of said in-place component, and, in the event that the in-place component is replaced by an equivalent component in the conditions specified by the protection software,

k) the communication by the terminal, to said transceiver of the external equipment, of the terminal key and of the component key of said equivalent component, and

l) the recording, in the database of the external equipment, of the component key of said equivalent component, this being for tracing purposes.

Together with the blocking of the terminal and whatever the cause, in step m), an alert message can be set from the terminal to the transceiver of the external equipment, or vice versa, or reciprocally, and possibly displayed and/or an alarm can be triggered.

A step n) may also be provided which consists of the locating of the terminal and the sending, by the latter, of its geographic coordinates to the transceiver of the external equipment. To this end, a GPS, for example, may be incorporated in the terminal. Step n) is advantageously executed automatically, from the moment the terminal is blocked, and its benefit is clear: locating the phone, or more generally the mobile equipment, locates the thief at the same time.

Most of the time, in the terminal intended to be protected, data is stored, the loss of which can be extremely troublesome (for example in the case of a phone directory) or which is of a confidential nature.

In one particular embodiment of the method according to the invention, the method includes, in the event of the terminal being blocked as a result of the execution of the abovementioned step c), e), or f), an additional step consisting of:

o) the transfer of all or some of the data stored in said terminal to the database of said external equipment and/or

p) the destruction of all or some of the data stored in the terminal.

Thus, in the case of step o), the authorized user will be able to retrieve all or some of his data from the database belonging to the external equipment, which database will store the data and return it to the authorized user, by download or via any suitable medium.

Step p) may consist in destroying either only the data which have been transferred during step o) described above, or only data which has been selected beforehand, for example as it is entered in the terminal, or all the data stored in said communication terminal. Such a method is particularly useful in the case of portable computers in order to enable the destruction of all personal files or files which the authorized user wishes to keep secret.

The software required to execute the method according to the invention and/or, if necessary, its unlocking will preferably be downloadable to the terminal from the external equipment. If the terminal is not capable of receiving such a download or being loaded from any medium (floppy disk, CD-ROM, etc.), the designer will need to perform the necessary adaptation.

According to another embodiment, the software can be directly installed within the device on a physical medium such as a card or a chip.

According to a second aspect of the present invention, the invention concerns an assembly formed first of a device the operation of which is likely to be under the control of software and, secondly, of at least one removable component, referred to as an “in-place component”, with which said device has a dependence and/or proximity link, said device being loaded with protection software in which an activation code that is personal to the authorized user of the device is recorded and which is designed to:

β) allow the authorized user to temporarily break the dependence and/or proximity link between his terminal and said removable component, and

β) block the terminal, if it turns out that the activation code was not entered before the breakage of the dependence and/or proximity link.

Advantageously, the device can additionally include:

γ) means for triggering, through the effect of entering the activation code, a timer providing the time required to break and re-establish the dependence and/or proximity link, and

δ) blocking means acting on the device if said dependence and/or proximity link was not re-established before the end of the time period of the timer.

It can further include:

ε) blocking means acting on the device in the event of successive inputs of a predetermined number of erroneous activation codes.

To execute the various steps described above relating to the method applied to the case of a plurality of devices each consisting of a communication having a dependence and/or proximity link with at least one removable component, referred to as an “in-place component”, each terminal and each removable component having specific key, respectively referred to as “terminal key” and “component key”, the invention brings forth an installation formed of a plurality of such terminals and of external equipment including a transceiver and a database, designed to record, for each terminal, at least one item of data identifying the authorized user, and the terminal key and component key information which is communicated to it by said terminal.

Of course, if a given terminal has a dependence and/or proximity link with several in-place components and if several of these in-place components have been replaced with equivalent components under the conditions authorized by the protection software, the terminal can communicate the component key of each of the substitute equivalent components to the external equipment.

The installation can additionally conclude:

ζ) means for sending, in the event of a terminal being blocked, an alert message from the terminal concerned to the transceiver of the external equipment, or vice versa, or reciprocally, and possibly means for displaying such a message and/or for triggering an alarm, which sending/displaying and/or triggering means are activated together with said blocking means, and/or

η) means for locating the terminal and for the sending, by the latter, of its geographic coordinates to the transceiver of the external equipment.

The installation also includes, as a preference:

θ) means for unblocking a blocked terminal, which means are likely to be executed from the external equipment.

Applied to the protection of terminals in which data is stored, the installation advantageously includes:

τ) means for transferring all or some of the data stored in the terminal concerned to the database of said external transceiver in the event of a terminal being blocked and/or

κ) means of destroying all or some of the data stored in said terminal in the event of the latter being blocked.

The invention will be better understood, and its advantages will become more apparent, in the light of the following detailed description given with reference to the accompanying drawings in which:

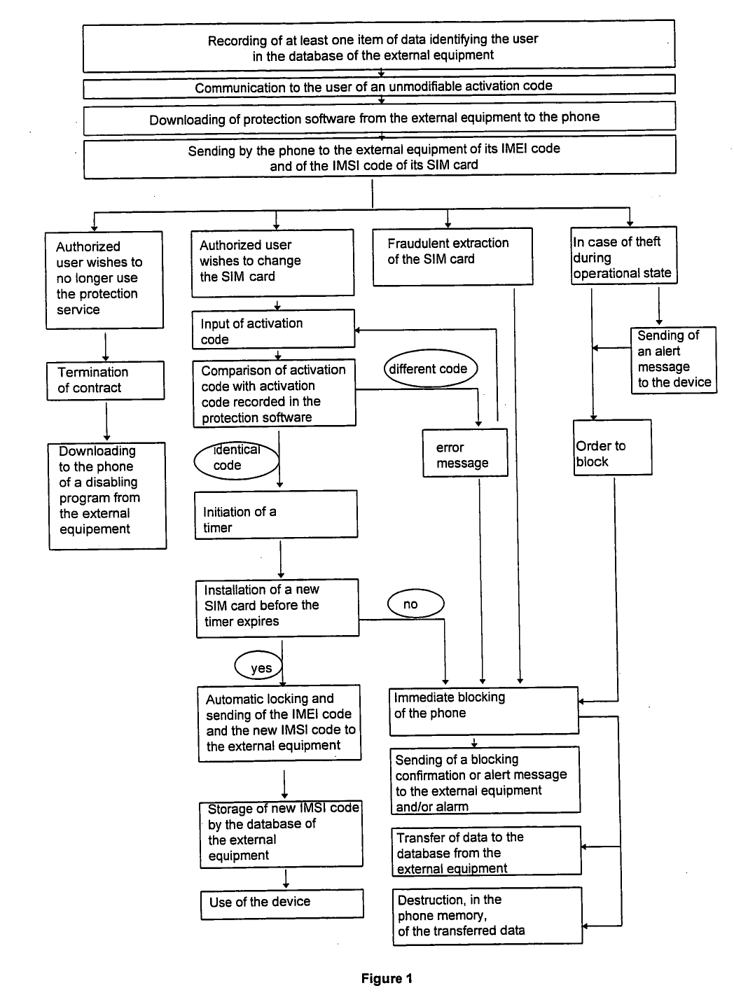

FIG. 1 shows a flowchart illustrating one embodiment of the method according to the invention, applied to the protection of a mobile phone and

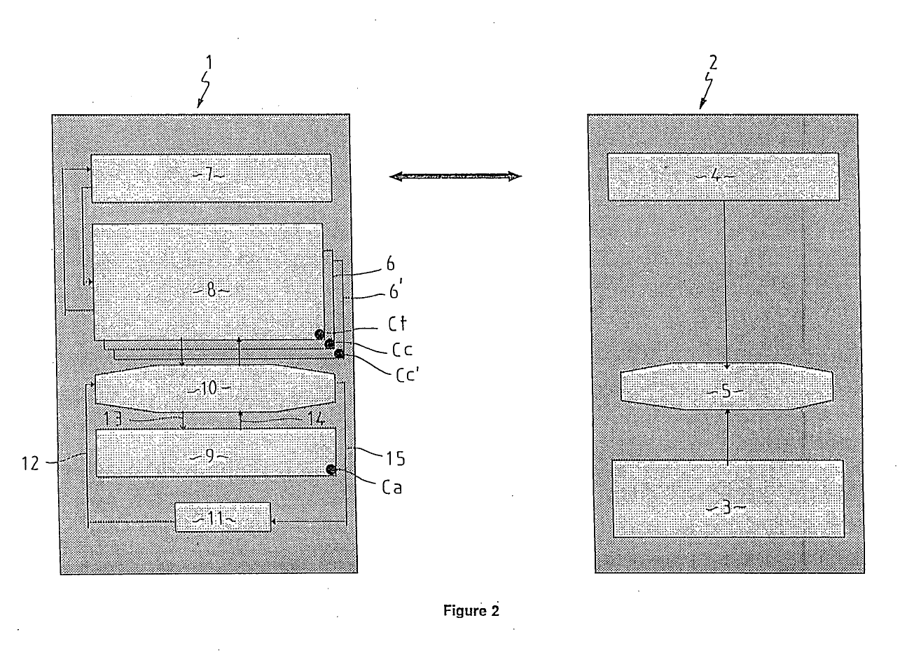

FIG. 2 is a schematic representation of one embodiment of the installation according to the invention, of a more generalized application.

Referring to FIG. 1, the various steps of one embodiment of the method according to the invention can be seen, which embodiment requires recourse to a service provider, controller of that which was earlier referred to as the external equipment.

The first step, for a user wishing to take advantage of the services in question, consists in registering in the database of the external equipment at least one item of data enabling the user to be identified, which data can be, for example, his name, address, phone number etc.

After this registration is performed, the user becomes an “authorized user” for the external equipment and the protection system controller supplies him with an unmodifiable activation code for the unlocking/timer/locking program for his phone as managed by protection software which is downloaded to the phone from the transceiver of the external equipment. The code can be supplied to the authorized user by mail or any other confidential means. The activation code is also recorded by the protection system controller in the downloaded software without being accessible, from this software, to any user of the phone.

During the next phase, the mobile phone communicates to the external equipment

its IMEI code or a code associated with any equivalent identification device, and

the IMSI code of the SIM card installed in the device.

The anti-theft protection according to the invention does not in any way alter normal usage of the phone by the authorized user.

It intervenes only in the event of changing of the SIM card. If the authorized user of the phone wishes to replace the installed SIM card (sequence 1), for example if he lends his mobile phone to a third party who has his own SIM card and wishes to make use of the phone on his own subscription, the authorized must first enter the activation code which was communicated to him by the protection service controller.

The code entered is compared with that which was recorded, by the protection service controller, in the downloaded software and, if it is correct, (sequence 1.A), this has the effect of initiating a timer during which a change of SIM card may take place.

If the change has indeed taken place before the end of timer period, the phone is automatically locked (sequence 1.A.1) with communication, by the phone to the transceiver of the external equipment, of the IMEI code of the phone or of the code associated with an equivalent identification device, in order to identify the authorized user, and communication of the IMSI code of the substitute SIM card, which code is stored by the database of the external equipment and which, thereafter, will be considered as being the key of the in-place component, which component is recognized as the authorized component. This information saved in the database of the external equipment enables accurate tracing and various actions to restrict fraud linked to the use of the phone and its removable component(s).

The phone then operates normally, and no other operation needs to be performed.

If the SIM card change was not performed before the end of the timer period, the operation of the phone is immediately blocked (sequence 1.A.2).

If the authorized user carries out the change too slowly and if his phone is then blocked, he must contact the protection service controller to have it unblocked.

If the activation code entered in the phone via the keypad is incorrect (sequence 1.B), an error message is displayed. Three successive errors results in the phone being blocked.

Once again, if the errors are made by the authorized user, he can have his phone unblocked by contacting the protection service controller.

If the installed SIM card is extracted without first entering the activation code (sequence 2), which happens most often in the case of phone theft, the phone is then immediately and automatically blocked. If this extraction is carried out absent-mindedly by an authorized user, the phone can be unblocked as described above.

As regards blocking, this takes place by means of the software loaded in the phone, without intervention of the external equipment, which software reacts as soon as there is an attempt to replace the in-place component with an equivalent component without first entering the activation code, if there are three successive errors on entering the activation code, or if the timer period after entering the correct activation code is exceeded. Such blocking can be performed by any means known to the person skilled in the art, for example deactivating a unit in the phone such as blocking operation of the keypad keys.

As regards unblocking, as described above, this is performed by the external equipment, again employing any means known to the person skilled in the art, such as downloading unblocking instructions.

As a preference and regardless of the cause of blocking of the phone, an alert message will be sent, and possibly displayed, from the phone to the external transceiver, or vice versa, or reciprocally. An alarm may be triggered. Thus, in the event of an attempted unauthorized substitution of the SIM card or in the event of the time available for an authorized substitution being exceeded, an “operation blocked” message can appear on the screen of the phone and an alarm may be triggered, which, in the case of theft, will indicate to the thief the uselessness of his act and, in the case of the timer period expiring, will inform the authorized user of the need to contact the protection system controller.

Under the same circumstances, a message may be received or displayed by the external transceiver, which, in the case of theft of the phone, can enable the protection service controller to notify the authorized user that the operation of his lost or stolen device has been blocked.

In one preferred embodiment of the invention, regardless of the reason for the phone being blocked, all or some of the data contained therein, for example the phone directory, will be transferred to and stored in the database of the external equipment which will return it to the authorized user in any suitable way, preferably by downloading from the external equipment either to the phone of said authorized user if he is still in possession of it in the case of blocking by his action, or to a new replacement phone in the case of a theft.

The data transferred to the database of the external equipment and stored there temporarily may simultaneously be destroyed in the memory of the phone thus preventing anyone other than the authorized user from having access to it.

If the authorized user no longer wishes to use the protection service according to the invention, he need simply (sequence 3) terminate the contract entered into with the controller of said service, the external equipment downloading a program to disable the protection software downloaded previously to the phone, with the result that replacement of the installed SIM card with another is once again possible without an activation code.

The present invention also takes into consideration the case of the phone being stolen while it is in operation. In this state, the thief will be able to use the stolen phone until the battery is exhausted.

To avoid such a scenario, provision is made (sequence 4) for the external equipment, after the owner of the phone has notified the service controller of the theft, to be able to directly send a blocking command to the phone which command can if necessary be accompanied by an alert message and/or an alarm.

The phone is then irreversibly blocked while the data contained in the phone can be transferred to the external equipment and/or destroyed from the memory of the phone.

Although for convenience reference has been made hereinabove to the protection of a mobile phone, it must be clearly understood that the method can be applied to any communication terminal, as defined previously, or even, in its simplest embodiment, to any device the operation of which is likely to be under the control of software.

Referring now to FIG. 2, this represents an example of an installation according to the present invention, of more generalized application.

More specifically, the installation consists of a series of communication terminals of which only one 1 is represented and external equipment 2 including a database 3 able to record, in particular, at least one item of data identifying the authorized user and one activation code Cₐ for each of the terminals, a transceiver 4 which is in communication with said terminals and reciprocally, and an information processing device 5 linking said transceiver 4 and said database 3. The communication can be of electronic, magnetic, etc. nature.

Each communication terminal 1, with which a terminal key Cₜ is associated, has a dependence link with at least one removable component, referred to as an “in-place component” 6, 6′ with which a component key C_{c}, C_{c}′ is associated. The terminal 1 includes a communication device 7 able to communicate with the transceiver 4 of the external equipment 2, a storage space 8 for storing information internal to the terminal (terminal key Cₜ) and information internal to each in-place component (component keys C_{c}, C_{c}′), a storage space 9 for storing information external to the apparatus (protection software and activation code Cₐ) and an information processing unit 10 linking the two storage spaces 8 and 9.

The communication device 7 of each terminal is capable of communicating, to the transceiver 4 of the external equipment, its terminal key Cₜ and the component key(s) C_{c}, C_{c}′ of its in-place components for recording in the database 3. Moreover, after an authorized change of one of the in-place components 6, 6′ by an equivalent component, said database 3 records the component key of said equivalent component.

The terminal 1 additionally includes a keypad 11 by means of which the activation code Cₐ can be entered in the terminal and transmitted, as indicated by 12, to the information processing unit 10 which sends it, as indicated by 13, to the storage space 9 for comparison, by the protection software, with the activation code which is recorded therein. As indicated by 14, the result of the comparison is returned to the processing unit 10. If the activation code entered is correct, the user can remove or disconnect an in-place component 6 and replace this component or reconnect it within the time allowed by the software. Otherwise, the protection software sends, as indicated by 14, blocking instructions, for example to block the keypad 11, as indicated by the line 15.

Such blocking instructions are also sent if it turns out that the in-place component 6 or 6′ is removed without entering the activation code Cₐ.

As for the rest, operation is as was described earlier in relation to FIG. 1, where necessary, mutatis mutandis. Although, in the embodiments illustrated by the figures, reference is made to systems relying on the breakage of a dependence link, it is clear that the explanations given apply equally as well to systems relying on the breakage of a proximity link.

As is apparent from the above description, the invention can be used just as well to prevent the use of a stolen or lost device, as it can to find the owner of a device that has been found. Furthermore, since the protection is permanently in force, without intervention by the user, this makes for a favorable factor as far as insurance comies are concerned.

1. A method for combating the theft and/or fraudulent use of a device (1) the operation of which is likely to be under the control of software and which has a dependence and/or proximity link with at least one removable component, referred to as an “in-place component (6, 6′)”, which method is characterized in that it includes the following steps:
a) the loading, into said device (1), of protection software in which an activation code (Cₐ) that is personal to the user is recorded and which the user requires in order to be able to break said dependence and/or proximity link,
b) the provision of said activation code (Cₐ) to the authorized user, and, if said activation code (Cₐ) was not entered in the device (1) before the breakage of said dependence and/or proximity link:
c) the blocking of the operation of the device (1), under the command of said protection software.

2. The method as claimed in claim 1, characterized in that it additionally includes a step consisting of:
d) the initiation, through the effect of entering the activation code (Cₐ) in the device (1), of a timer providing the time required to break and re-establish the dependence and/or proximity link, and if necessary
e) the blocking of the device (1) if the dependence and/or proximity link was not re-established before the end of said time period of the timer.

3. The method as claimed in claim 1 or 2, characterized in that it additionally includes a step consisting of:
f) the blocking of the device (1) in the event of successive inputs of a predetermined number of erroneous activation codes.

4. The method as claimed in any of the preceding claims, characterized in that it additionally includes a step consisting of:
g) the unblocking of said device by the provider of the activation code.

5. The method as claimed in any of the preceding claims which method is applied to the case in which the device (1) is a communication terminal, said terminal (1) and said in-place component (6, 6′) each having its specific key, respectively referred to as “terminal key (Cₜ)” and “component key (C_{c}, C_{c}′)”, which method is characterized in that it additionally includes the steps consisting of:
h) the recording in external equipment (2), including a database (3) and a transceiver (4), of at least one item of data identifying the authorized user of said terminal (1);
i) the communication by the terminal (1), to said transceiver (4) of the external equipment (2), of the terminal key (Cₜ) and of the component key (C_{c}, C_{c}′) of said in-place component (6, 6′) during first use of the method;
j) the recording, in said database (3), of the terminal key (Cₜ) and of the component key (C_{c}, C_{c}′) of said in-place component (6, 6′), and, in the event that the in-place component (6, 6′) is replaced by an equivalent component in the conditions specified by the protection software,
k) the communication by the terminal (1), to said transceiver (4) of the external equipment (2), of the terminal key (Cₜ) and of the component key of said equivalent component, and
l) the recording, in the database (3) of the external equipment (2), of the component key of said equivalent component.

6. The method as claimed in claim 5, characterized in that it includes an additional step consisting of:
m) the sending of an alert message from the terminal (1) to the transceiver (4) of the external equipment (2), or vice versa, or reciprocally, and possibly its display and/or the triggering of an alarm, and/or
n) the locating of the terminal (1) and the sending, by the latter, of its geographic coordinates to the transceiver (4) of the external equipment (2).

7. The method as claimed in claim 5 or 6, characterized in that it includes, in the event of the terminal (1) being blocked as a result of the execution of the abovementioned step c), e), or f), an additional step consisting of:
o) the transfer of all or some of the data stored in said terminal (1) to the database (3) of said external equipment (2) and/or
p) the destruction of all or some of the data stored in the terminal (1).

8. The method as claimed in any of claims 4 to 7, characterized in that it consists in unblocking a blocked terminal (1) by downloading unblocking instructions from the external equipment (2) to said terminal.

9. An assembly formed first of a device (1) the operation of which is likely to be under the control of software and, secondly, of at least one removable component, referred to as an “in-place component (6, 6′)”, with which said device (1) has a dependence and/or proximity link, which assembly is characterized in that said device (1) is loaded with protection software in which an activation code (Cₐ) that is personal to the authorized user of the device (1) is recorded and which is designed to:
α) allow the authorized user to temporarily break the dependence and/or proximity link between his terminal (1) and said in-place component (6, 6′), and
β) block the terminal (1), if it turns out that the activation code (Cₐ) was not entered before the breakage of the dependence and/or proximity link.

10. The assembly as claimed in claim 9, characterized in that said device (1) additionally includes:
γ) means for triggering, through the effect of entering its activation code (Cₐ), a timer providing the time required to break and re-establish the dependence and/or proximity link, and
δ) blocking means acting on the device (1) if said dependence and/or proximity link was not re-established before the end of the time period of the timer.

11. The assembly as claimed in claim 9 or 10, characterized in that it additionally includes:
ε) blocking means acting on the device (1) in the event of successive inputs of a predetermined number of erroneous activation codes.

12. An installation, characterized in that it is formed of:
a plurality of devices each consisting of a communication terminal (1) having a dependence and/or proximity link with at least one removable component, referred to as an “in-place component” (6, 6′)″, each terminal (1) and each in-place component (6, 6′) having its specific key, respectively referred to as “terminal key (Cₜ)” and “component key (C_{c}, C_{c}′)”, and
external equipment (2) including a transceiver (4) and a database (3), designed to record, for each terminal (1), at least one item of data identifying the authorized user, and the terminal key (Cₜ) and component key (C_{c}, C_{c}′) information which is communicated to the external equipment (2) by said terminal (1).

13. The installation as claimed in claim 12, characterized in that it additionally includes:
ζ) means for sending, in the event of a terminal (1) being blocked, an alert message from the terminal concerned to the transceiver (4) of the external equipment (2), or vice versa, or reciprocally, and possibly means for displaying such a message and/or for triggering an alarm, which sending/displaying and/or alarm means are activated together with said blocking means, and
η) means for locating the terminal and for the sending, by the latter, of its geographic coordinates to the transceiver of the external equipment.

14. The installation as claimed in claim 10 or 11, characterized in that it additionally includes:
θ) means for unblocking a blocked terminal (1), which means are likely to be executed from the external equipment (2).

15. The installation as claimed in any of claims 12 to 14, and which installation is applied to the protection of terminals (1) in which data is stored, which installation is characterized in that it additionally includes:
τ) means for transferring all or some of the data stored in the terminal (1) concerned to the database (3) of said transceiver (4) of the external equipment in the event of a terminal (1) being blocked and/or
κ) means of destroying all or some of the data stored in said terminal (1) in the event of the latter being blocked.
